(19) United States
(12) Patent Application Publication
(10) Pub. No.: US 2025/0226150 A1
(43) Pub. Date: Jul. 10, 2025

(54) DISTRIBUTION TRANSFORMER EQUIPPED WITH SEMICONDUCTOR TAP SWITCHING APPARATUS

(71) Applicant: E-KYOUNG SYSTEMS CO., LTD., Gimpo-si (KR)

(72) Inventor: Eul Jae LEE, Gwangmyeong-si (KR)

(21) Appl. No.: 18/439,998

(22) Filed: Feb. 13, 2024

(30) Foreign Application Priority Data
Jan. 5, 2024 (KR) 10-2024-0002222

(51) Int. Cl. H01F 27/40; H01F 27/30

(52) U.S. Cl. CPC H01F 27/40; H01F 27/306

(57) ABSTRACT

Proposed is a distribution transformer equipped with a semiconductor tap switching apparatus. In the distribution transformer, when a primary side input rated voltage is increased or decreased, taps of an auxiliary winding provided in a primary winding portion is switched by a semiconductor switch, so that a magnetic flux transmitted to a secondary side is changed, thereby being capable of maintaining an output voltage supplied to a load to be in a stable state.

### CROSS REFERENCE TO RELATED APPLICATION

The present application claims priority to Korean Patent Application No. 10-2024-0002222, filed Jan. 5, 2024, the entire contents of which are incorporated herein for all purposes by this reference.

### BACKGROUND OF THE INVENTION

### Field of the Invention

The present disclosure relates to a distribution transformer equipped with a semiconductor tap switching apparatus. More particularly, the present disclosure relates to a distribution transformer equipped with a semiconductor tap switching apparatus, the distribution transformer including a primary winding portion provided with a main winding and an auxiliary winding which is provided below the main winding and which has a plurality of taps, the distribution transformer including a plurality of semiconductor switches configured to switch the taps of the auxiliary winding and including a controller configured to control the plurality of semiconductor switches, thereby being capable of controlling a secondary side output voltage such that the secondary side output voltage is always within a stable range even when a primary side input rated voltage is changed.

### Description of the Related Art

Generally, in a high-voltage transmission and distribution line, a voltage drop due to an effect of an impedance along a length of the line has been considered a common characteristic. Accordingly, as a method for controlling the voltage drop, a method of controlling a tap of a substation transformer or a method of stabilizing a voltage applied to a consumer by controlling a tap in a pole transformer at an end of a line are used.

As an apparatus for controlling a secondary side voltage during a high voltage transmission and distribution process, an On Load Tap Changer (OLTC) configured to control a voltage by using a coil tap of a transformer, a Static Voltage Regulator (SVR) configured to sequentially control a tap voltage in the middle of a line, and so on are used.

As a related conventional technology, ‘TRANSFORMER USING ELECTRIC POWER DISTRIBUTION SPART OLTC’ has been proposed in Korean Patent No. 10-2219309 (Feb. 17, 2021).

In the conventional technology, when a plurality of taps is switched by a gear of a motor, a switching resistor is connected so as to prevent a first tap connector and a second tap connector from being short-circuited, thereby allowing a cycle current Ic to flow. Furthermore, an inter lock circuit is coupled so that a direct operation between an H contact point and an L contact point is prevented, the switching resistor limits the cycle current Ic generated by a switching circuit and makes the cycle current Ic and a load current I equal to each other, so that a space between the tap connectors is prevented from being short-circuited until a predetermined contact reaches a specific gear during a tap switching process.

As another conventional technology, ‘APPARATUS AND METHOD FOR CONTROLLING OF ON LOAD TAP CHANGER’ has been proposed in Korean Patent No. 10-1525595 (May 28, 2015). The apparatus includes a controlling portion which is provided with a sensor and a speed measurement portion that are configured to sense a rotation of a driving motor and to generate sensing information and speed information and which is configured to determine that failure of the driving motor or the on load tap changer occurs when a tap position and the speed information are less than a reference speed, and includes a display portion configured to display the tap position of the on load tap changer on the basis of position information.

However, in the mechanical tap switching method of the conventional technology as described above, due to limitations in lifespan such as wear and so on, the number of times the tap can be switched per day is limited. Particularly, in the mechanically operated method, there is a problem that a rapid voltage control is actually impossible.

Meanwhile, due to the expansion of the use of new and renewable energy such as solar photovoltaic power generation, as external distributed power devices connected to the existing power grid increase significantly, there is a phenomenon that a voltage of a line does not only decrease in proportion to a length of the line, but also increases in some cases or decreases rapidly in other cases. Furthermore, in a distribution transformer directly connected to a customer, a significant voltage fluctuation of the daily voltage is observed due to the influence of the surrounding solar photovoltaic power generation complex and so on. Particularly, there is a problem that the voltage is rapidly increased during the daytime and then the voltage is suddenly dropped in the evening due to the increase of the load amount.

In order to solve this problem, the increase and decrease of the voltage is controlled by applying a Static Voltage Regulator (SVR) described above. However, due to the limitation of the mechanical tap switching method, rapid control and response to frequent fluctuation are insufficient.

### SUMMARY OF THE INVENTION

Accordingly, the present disclosure has been made keeping in mind the above problems occurring in the related art, and an objective of the present disclosure is to provide a distribution transformer equipped with a semiconductor tap switching apparatus, the distribution transformer including a primary winding portion provided with a main winding and an auxiliary winding having a plurality of taps, and the distribution transformer being configured to control a secondary side output voltage in a multi-level manner by turning on and off a switch portion connected to the taps, thereby being capable of supplying a stable output voltage not only in a boosted state by an external distributed power device but also in an increased load state.

In order to achieve the objectives described above, according to an embodiment of the present disclosure, there is provided a distribution transformer connected to a distribution line and mounted so as to supply a low voltage required for a consumer, the distribution transformer being equipped with a semiconductor tap switching apparatus, and the distribution transformer including: a primary winding portion provided with a main winding on which a coil is wound multiple times, the primary winding portion being provided with an auxiliary winding which is wound in the same direction as the main winding at a lower portion of the main winding and which has a plurality of taps such that multi-level voltages are generated; a switch portion provided with a plurality of first switches connected between the main winding and the taps and configured to be switched, the switch portion being provided with a plurality of second switches connected between the taps and a ground and configured to be switched; a secondary winding portion on which a coil corresponding to the primary winding portion is wound at a predetermined number of rotations; a power sensing portion configured to sense a voltage and a current that are applied to the main winding; a bypass switch connected between the main winding and the ground and configured to be switched such that a circuit bypassing the auxiliary winding is formed; and a controller configured to sense an output voltage of the secondary winding portion and to turn on and off the switch portion and the bypass switch.

A plurality of branch windings wound in multiples of an integer may be coupled to the auxiliary winding so that a voltage ratio between the taps is set to an integer ratio.

When the controller forms a circuit that passes through the branch windings, the controller may be controlled such that any one of the first switches is turned on and any one of the second switches is turned on.

As such, the distribution transformer equipped with the semiconductor tap switching apparatus according to the present disclosure has the following effects.

First, since the distribution transformer according to the present disclosure is configured such that the tap switching is turned on and off by the semiconductor switch, the voltage fluctuation may be controlled more rapidly than the conventional mechanical tap switching transformer.

Second, since the primary winding portion is controlled by the semiconductor switching method, long-term maintenance due to wear or aging of mechanical configurations such as a motor or a rotation tap provided in a mechanical switching apparatus is not required, so management that is significantly simplified.

Third, due to the auxiliary winding having a significantly smaller number of taps connected to the semiconductor switch, there is an advantage that the durability of the switching apparatus and the overall reliability of the device are significantly increased.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating a configuration of a distribution transformer equipped with a semiconductor tap switching apparatus according to an embodiment of the present disclosure;

FIG. 2 are views illustrating states in which a switch portion according to an embodiment of the present disclosure is switched to a tap 6 state and a tap-6 state;

FIG. 3 is a view illustrating a state in which the switch portion according to an embodiment of the present disclosure is switched to a tap zero state;

FIG. 4 are views illustrating states in which the switch portion according to an embodiment of the present disclosure is switched to a tap 3 state and a tap-3 state; and

FIG. 5 is a view illustrating an operation principle of the transformer according to the present disclosure.

### DETAILED DESCRIPTION OF THE INVENTION

Hereinafter, an embodiment of the present disclosure will be described in detail with reference to the accompanying drawings.

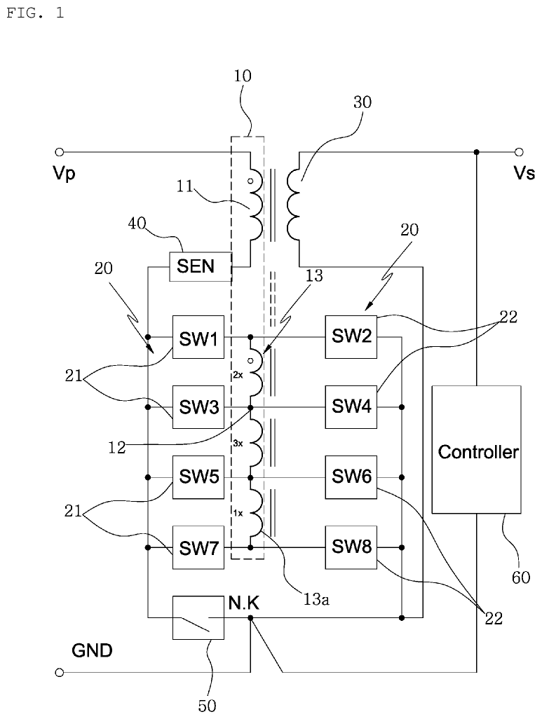

As illustrated in FIGS. 1 to 5, a distribution transformer equipped with a semiconductor tap switching apparatus according to the present disclosure is a distribution transformer connected to a distribution line and mounted such that low voltage required for a consumer is supplied. Furthermore, the distribution transformer includes: a primary winding portion 10 provided with a main winding 11 on which a coil is wound multiple times, the primary winding portion 10 being provided with an auxiliary winding 13 which is wound in the same direction as the main winding 11 at a lower portion of the main winding 11 and which has a plurality of taps 12 such that multi-level voltages are generated; a switch portion 20 provided with a plurality of first switches 21 connected between the main winding 11 and the taps 12 and configured to be switched, the switch portion 20 being provided with a plurality of second switches 22 connected between the taps 12 and a ground GND and configured to be switched; a secondary winding portion 30 on which a coil corresponding to the primary winding portion 10 is wound at a predetermined number of rotations; a power sensing portion 40 configured to sense a voltage and a current that are applied to the main winding 11; a bypass switch 50 connected between the main winding 11 and the ground GND and configured to be switched such that a circuit bypassing the auxiliary winding 13 is formed; and a controller 60 configured to sense an output voltage of the secondary winding portion 30 and to turn on and off the switch portion 20 and the bypass switch 50.

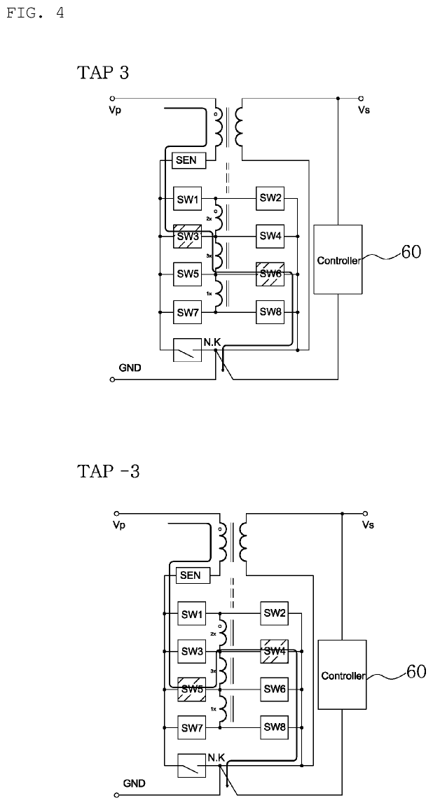

Here, in the primary winding portion 10, most of the input rated voltage is generated in the main winding 11, and the fluctuation voltage to be fluctuated is handled by the auxiliary winding 13 divided by the plurality of taps 12. That is, the auxiliary winding 13 is configured such that a secondary side voltage is controlled according to the number of coil rotations (2x, 3x, and 1x) between each tap. Meanwhile, unlike a zero tap state illustrated in FIG. 4, the bypass switch 50 is turned on when the switch portion 20 fails, and passes only the main winding 11, thereby configuring a primary side circuit.

In addition, the power sensing portion 40 includes an AC transformer, a voltmeter, or the like.

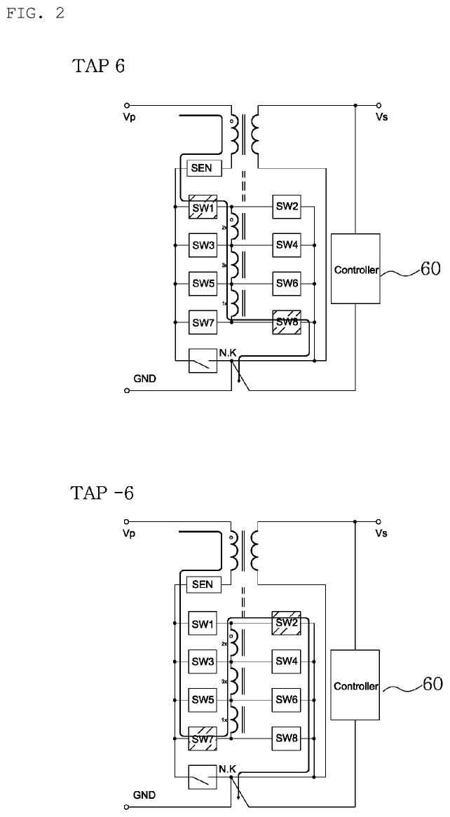

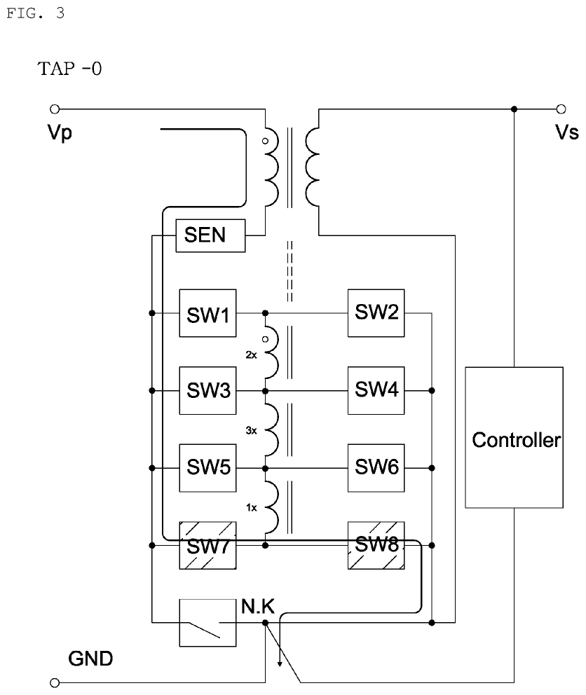

Meanwhile, a switch in a turned on state is illustrated as a hatched line shape in the drawings, FIG. 2 are views illustrating controlled states in which the switch portion is switched to a tap 6 state and a tap-6 state, FIG. 3 is a view illustrating a controlled state in which the switch portion is switched to a tap zero state, and FIG. 4 are views illustrating controlled states in which the switch portion is switched to a tap 3 state and a tap-3 state.

In addition, most of power semiconductor capable of turning on and off a current may be used as the first switches 21 and the second switches 22 that are constituting the switch portion 20. Furthermore, according to the amount of current, the first switch 21 and the second switch 22 may be configured by employing most of active type semiconductor devices, from MOSFET to Thyristor.

Meanwhile, a plurality of branch windings 13a wound in multiples of an integer is coupled to the auxiliary winding 13 so that a voltage ratio between the taps 12 is set to an integer ratio. That is, the number of rotations of the plurality of branch windings 13a may be a proportional combination of winding in multiples of 2x: 3x: 1x as illustrated in the drawings. Here, x is determined as a reference value of the voltage fluctuation that is added or subtracted.

That is, when the controller 60 forms a circuit that passes through the branch windings 13a, the controller 60 is controlled such that any one of the first switches 21 is turned on and any one of the second switches 22 is turned on. Any one of SW1, SW3, SW5, and SW7 in the first switches 21 is turned on, and any one of SW2, SW4, SW6, and SW8 in the second switches 22 is turned on, so that a circuit of the branch windings 13a is formed.

An operation of the distribution transformer equipped with the semiconductor tap switching apparatus according to the present disclosure having the configuration as described above is as follows.

As illustrated in FIGS. 1 to 5, in the distribution transformer equipped with the semiconductor tap switching apparatus according to the present disclosure, the controller 60 senses an output voltage of the secondary winding portion 30, controls the first switches 21 and the second switches 22 of the switch portion 20, and controls the bypass switch 50, thereby adjusting the output voltage. Generally, 13, 200 V is used as an input voltage of the distribution transformer, and 1,320 V is applied to the auxiliary winding 13 when the distribution transformer is configured to correspond to the 10% voltage fluctuation.

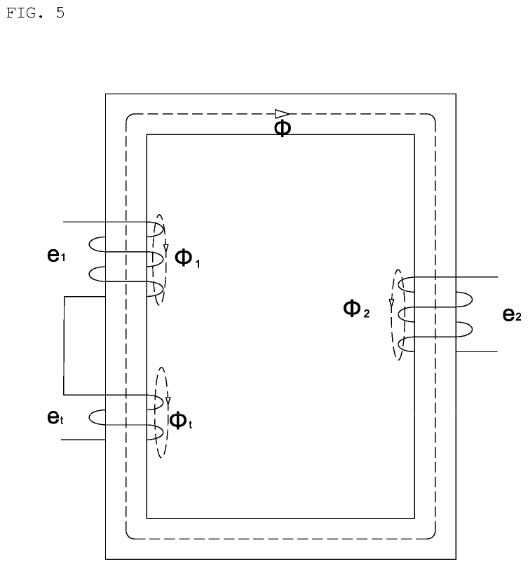

To describe with a specific example, as illustrated in FIG. 5, a secondary side electromotive force e₂ generated for a change in a primary side alternating magnetic flux is determined by Equation 1.

$${e}_{2} = - {N}_{2} \frac{d {Φ}_{2}}{dt} , \qquad ( Equation 1 )$$

Here, N₂ is a winding number (Amp-turn), and Φ indicates a magnitude of a magnetic flux generated in a transformer core.

Meanwhile, when a magnetic flux generated in the coil by a primary side voltage is Φ1 and a magnetic flux generated in the branch windings 13a is Φₜ, an overlapping magnetic flux Φ that flows in the core is expressed by Equation 2.

$$Φ = {Φ}_{1} \pm {Φ}_{t} \qquad ( Equation 2 )$$

That is, when the magnitude and the direction of the magnetic flux generated in the branch windings 13a are changed, the magnitude of the secondary voltage e₂ is changed by Equation 1. Conversely, when the magnitude of the first voltage is fluctuated, the magnetic flux of the branch windings 13a is changed, so that the second side voltage is controlled.

Meanwhile, the winding ratio of the branch windings 13a may be changed from a tap 1 to a tap 6 by controlling the first switches 21 and the second switches 22 with a proportional combination of 2:3:1. At this time, when the first switches 21 and the second switches 22 are controlled so that the current is applied in a reverse direction, the winding ratio of the branch windings 13a may be changed from a −1 tap to a −6 tap.

That is, when no operation in the branch windings 13a is regarded as the zero tap, the input voltage may be precisely controlled in 13 levels having the −6 tap, the −5 tap, the −4 tap, the −3 tap, the −2 tap, the −1 tap, the zero tap, the 1 tap, the 2 tap, the 3 tap, the 4 tap, the 5 tap, and the 6 tap.

Since the magnitude of the tap voltage x is 220 V (1320/6 tap), the voltage is fluctuated by 220 V each time the tap is increased or decreased. When the primary side voltage is in the range of 14,520 V (110%) to 11,880 V (90%), which is ±10% on the basis of 13,200 V, the tap corresponding to ±1,320 V/n is controlled in the auxiliary winding 13, thereby being capable of consistently maintaining the secondary side voltage within the error range of 1.67% compared to the rated voltage.

The winding ratio 2x: 3x: 1x illustrated in FIGS. 2 to 5 of the present disclosure is not limited thereto, and the number of branch windings 13a wound with various windings may be determined according to the maximum amount of voltage control.

As such, in the distribution transformer equipped with the semiconductor tap switching apparatus according to the present disclosure, when the input rated voltage is increased or decreased, the voltage is capable of being rapidly changed and supplied by using the semiconductor tap switching apparatus, and there is an effect that the long-term maintenance is easily performed since the durability and the reliability of the apparatus are improved than that of the mechanical switching apparatus.

The present disclosure is not limited to the specific preferred embodiments described above, and any person of ordinary skill in the art to which the present disclosure pertains may implement various modifications without departing from the gist of the present disclosure claimed in the claims. Furthermore, it is obvious that such modifications will fall within the scope of the description of the claims.

What is claimed is:

1. A distribution transformer connected to a distribution line and mounted so as to supply a low voltage required for a consumer, the distribution transformer being equipped with a semiconductor tap switching apparatus, and the distribution transformer comprising:
a primary winding portion provided with a main winding on which a coil is wound multiple times, the primary winding portion being provided with an auxiliary winding which is wound in the same direction as the main winding at a lower portion of the main winding and which has a plurality of taps such that multi-level voltages are generated;
a switch portion provided with a plurality of first switches connected between the main winding and the taps and configured to be switched, the switch portion being provided with a plurality of second switches connected between the taps and a ground and configured to be switched;
a secondary winding portion on which a coil corresponding to the primary winding portion is wound at a predetermined number of rotations;
a power sensing portion configured to sense a voltage and a current that are applied to the main winding;
a bypass switch connected between the main winding and the ground and configured to be switched such that a circuit bypassing the auxiliary winding is formed; and
a controller configured to sense an output voltage of the secondary winding portion and to turn on and off the switch portion and the bypass switch.

2. The distribution transformer of claim 1, wherein a plurality of branch windings wound in multiples of an integer is coupled to the auxiliary winding so that a voltage ratio between the taps is set to an integer ratio.

3. The distribution transformer of claim 2, wherein, when the controller forms a circuit that passes through the branch windings, the controller is controlled such that any one of the first switches is turned on and any one of the second switches is turned on.
